(19) United States
(12) Patent Application Publication
(10) Pub. No.: US 2026/0360980 A1
(43) Pub. Date: Nov. 12, 2026

(54) DUAL POLARIZATION ANTENNA ELEMENT AND POLARIZATION RECONFIGURATION ANTENNA SYSTEM USING THE SAME

(71) Applicant: Kreemo Inc., Seoul (KR)

(72) Inventors: Baek Jun SEONG, Hwaseong-si (KR); Jun Ho PARK, Seoul (KR); In Kyung HONG, Seoul (KR); John Joonho PARK, Seongnam-si (KR)

(73) Assignee: Kreemo Inc., Seoul (KR)

(21) Appl. No.: 19/544,054

(22) Filed: Feb. 19, 2026

(30) Foreign Application Priority Data
May 12, 2025 (KR) 10-2025-0060921

(51) Int. Cl. H01Q 5/392; H01Q 1/38

(52) U.S. Cl. CPC H01Q 5/392; H01Q 1/38

(57) ABSTRACT

Disclosed herein are a dual polarization antenna element and a polarization reconfiguration antenna system using the same. The antenna element may include a metal plate, a first substrate joined to one side of the metal plate and including at least one antenna feeding port, and a second substrate joined to the other side of the metal plate and including a transmission path for an RF (Radio Frequency) signal input and output through the at least one antenna feeding port. The first substrate and the second substrate may be coupled to the metal plate by at least one conductive pin.

### CROSS-REFERENCE TO RELATED APPLICATION

This application claims the benefit of and priority to Korean Patent Application No. 10-2025-0060921, filed on May 12, 2025, the entire disclosure(s) of which is hereby incorporated herein by reference in its entirety.

### TECHNICAL FIELD

The present disclosure relates to an antenna and, more particularly, to a sandwich-type dual polarization antenna element having a pin-based connection structure, and a polarization reconfiguration antenna system using the same.

### BACKGROUND

An antenna device is used to transmit or receive wireless signals and has been developed in various forms and configurations to achieve higher performance. Recently, with the development of MIMO (Multiple-Input and Multiple-Output) technology for overcoming limitations in wireless communication capacity and beam forming technology for controlling a radiation direction of a signal to maximize transmission and reception signal strength between a base station and a terminal, an antenna device to which the MIMO and/or the beam forming technology is applied has also been developed.

In order to apply the beam forming technology to the antenna device, a multilayer PCB (Printed Circuit Board) or a package for integrating an antenna circuit and an RF (Radio Frequency) control circuit is generally required. However, compared to single-layer and double-layer PCBs, the multilayer PCB requires multiple stacking cycles and tolerance management for each layer, resulting in higher manufacturing costs and significantly longer manufacturing times. Further, it is advantageous for the antenna circuit to be directly formed on a substrate having low return loss, such as glass, and it is advantageous for the RF control circuit to be directly formed on a substrate having a low coefficient of thermal expansion. However, when both the antenna circuit and the RF control circuit are directly formed on a single substrate, such as the multilayer PCB, it becomes difficult to use materials optimized for each circuit.

Meanwhile, in a wireless communication system, since a terminal is movable unlike a base station or a repeater, severe signal attenuation may occur depending on changes in the position of the terminal. In particular, in a low orbit satellite communication system, polarization loss depending on an antenna direction may even lead to communication interruption. However, since a pattern formed in an inner layer of the PCB of the antenna device may not be modified, it is difficult to perform tuning for frequency adjustment or performance optimization.

Therefore, there is a need for an antenna device capable of optimizing antenna performance, reducing production costs, and implementing various polarizations.

### SUMMARY

In view of the above, one object of the present disclosure is to provide an antenna element capable of optimizing antenna performance and reducing production costs.

Another object of the present disclosure is to provide a polarization reconfiguration antenna system capable of implementing various polarizations.

Still another object of the present disclosure is to provide a method of manufacturing an antenna element capable of optimizing antenna performance, reducing production costs, and selectively radiating a desired polarization.

However, objects to be solved by the present disclosure are not limited thereto, and may be expanded in various ways without departing from the spirit and scope of the present disclosure.

The present disclosure provides an antenna element including a metal plate, a first substrate joined to one side of the metal plate and including at least one antenna feeding port, and a second substrate joined to the other side of the metal plate and including a transmission path for an RF (Radio Frequency) signal input and output through the at least one antenna feeding port, and the first substrate and the second substrate may be coupled to the metal plate by at least one conductive pin.

The first substrate and the second substrate may have different physical properties.

The first substrate and the second substrate may have different dielectric permittivities.

The first substrate and the second substrate may have different thicknesses.

The first substrate may have a thinner thickness than the second substrate.

The metal plate may include at least one through-hole into which the at least one conductive pin is inserted.

The transmission path and the at least one antenna feeding port may be electrically connected by the at least one conductive pin.

The at least one conductive pin may be soldered to at least one of the first substrate and the second substrate.

The at least one conductive pin may include a first conductive pin contacting a first antenna feeding port among the at least one antenna feeding port, and a second conductive pin contacting a second antenna feeding port among the at least one antenna feeding port, and a signal applied to the first conductive pin may be controlled to have a preset phase difference with respect to a signal applied to the second conductive pin.

The transmission path may include a first path connected to the first conductive pin, and a second path connected to the second conductive pin, and the first path and the second path may have different lengths.

A difference between the length of the first path and the length of the second path may be determined based on a wavelength of the RF signal.

A difference between the length of the first path and the length of the second path may be determined based on at least one of a thickness of the second substrate, a width of a trace formed in the second substrate, and physical properties of the second substrate.

The antenna element may include a time delay circuit configured to generate a time delay between the signal applied to the first conductive pin and the signal applied to the second conductive pin.

The time delay circuit may operate based on a frequency of the RF signal.

The antenna element may radiate at least one of linear polarization and circular polarization according to the phase difference between the signal applied to the first conductive pin and the signal applied to the second conductive pin.

The at least one conductive pin may include a first conductive pin contacting a first antenna feeding port among the at least one antenna feeding port, and a second conductive pin contacting a second antenna feeding port among the at least one antenna feeding port, and signals generated by different transceivers may be applied to the first conductive pin and the second conductive pin, respectively.

The present disclosure provides a polarization reconfiguration antenna system including an antenna module in which a plurality of antenna elements are arranged, and a control circuit configured to generate a signal applied to the antenna module, and the antenna module may include a metal plate, a first substrate provided on one side of the metal plate and including a plurality of antenna feeding ports, a second substrate provided on the other side of the metal plate and including transmission paths for RF signals input and output through the plurality of antenna feeding ports, and a plurality of conductive pins configured to join the metal plate, the first substrate, and the second substrate.

The present disclosure provides a method of manufacturing an antenna element, the method including placing a first substrate including at least one antenna feeding port on one side of a metal plate, placing a second substrate including a transmission path for an RF signal input and output through the at least one antenna feeding port on the other side of the metal plate, and joining the metal plate, the first substrate, and the second substrate using at least one conductive pin.

### ADVANTAGEOUS EFFECTS

The disclosed technology may have the following effects. However, it should not be construed that the scope of the disclosed technology is limited thereto, as it does not mean that a specific embodiment must include all or only the following effects.

An antenna element according to one embodiment of the present disclosure has a structure in which a substrate on which an antenna is provided and a substrate on which a control circuit is provided are joined to a metal plate by a conductive pin. Thus, according to one embodiment of the present disclosure, since a dual-band antenna element may be implemented using substrates having physical properties optimized for the antenna and the control circuit, respectively, instead of a multilayer PCB having high manufacturing cost, it is possible to reduce production costs while maximizing antenna performance.

Further, in an antenna element according to one embodiment of the present disclosure, feeding between a substrate on which an antenna is provided and a substrate on which a control circuit is provided is performed by a conductive pin. Therefore, according to one embodiment of the present disclosure, various polarizations may be implemented by adjusting a phase of a signal applied to the conductive pin.

### BRIEF DESCRIPTION OF THE DRAWINGS

FIG. 1 is a sectional view illustrating an antenna element according to one embodiment of the present disclosure.

FIG. 2 is a view illustrating a stacked structure of the antenna element according to one embodiment of the present disclosure.

FIG. 3 is a plan view illustrating an antenna element according to one embodiment of the present disclosure.

FIG. 4 is a view illustrating a case in which the antenna element according to one embodiment of the present disclosure operates in MIMO.

FIG. 5 is a plan view illustrating an antenna module included in a polarization reconfiguration antenna system according to one embodiment of the present disclosure.

FIG. 6 is a view illustrating return loss of the antenna element according to one embodiment of the present disclosure.

FIG. 7 is a view illustrating radiation efficiency of the antenna element according to one embodiment of the present disclosure.

FIG. 8 is a view illustrating a radiation pattern of the antenna element according to one embodiment of the present disclosure.

FIG. 9 is a view illustrating connection loss between substrates of the antenna element according to one embodiment of the present disclosure.

FIG. 10 is a view illustrating a method of manufacturing an antenna element according to one embodiment of the present disclosure.

### DETAILED DESCRIPTION

Since the present disclosure can be changed in various ways and have various embodiments, specific embodiments are illustrated in the drawings and described in detail in the detailed description.

However, the present disclosure is not limited to a specific embodiment, and all changes, equivalents, and replacements can be understood as being included in the spirit and scope of the present disclosure.

Although the terms “first”, “second”, etc. may be used herein to describe various components, these components should not be limited by these terms. These terms are only used to distinguish one component from another component. For instance, a first component could be termed a second component without departing from the scope of the present disclosure. Similarly, the second component could also be termed the first component. The term “and/or” includes any combination of a plurality of related listed items or any one of the plurality of related listed items.

It will be understood that when a component is referred to as being “coupled” or “connected” to another component, it can be directly coupled or connected to the other component or intervening components may be present therebetween. In contrast, it should be understood that when a component is referred to as being “directly coupled” or “directly connected” to another component, there are no intervening components present.

The terminology used herein is for the purpose of describing particular embodiments only and is not intended to be limiting. In the present disclosure, the singular forms are intended to include the plural forms as well, unless the context clearly indicates otherwise. It will be further understood that the terms “comprise” or “have”, etc. when used in this specification, specify the presence of stated features, integers, steps, operations, components, parts, and/or combinations thereof but do not preclude the presence or addition of one or more other features, integers, steps, operations, components, parts, and/or combinations thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

Hereinafter, preferred embodiments of the present disclosure will be explained in detail with reference to the accompanying drawings. In describing the present disclosure, the same reference numerals are used to designate the same components throughout the drawings to facilitate overall understanding, and redundant descriptions of the same components are omitted.

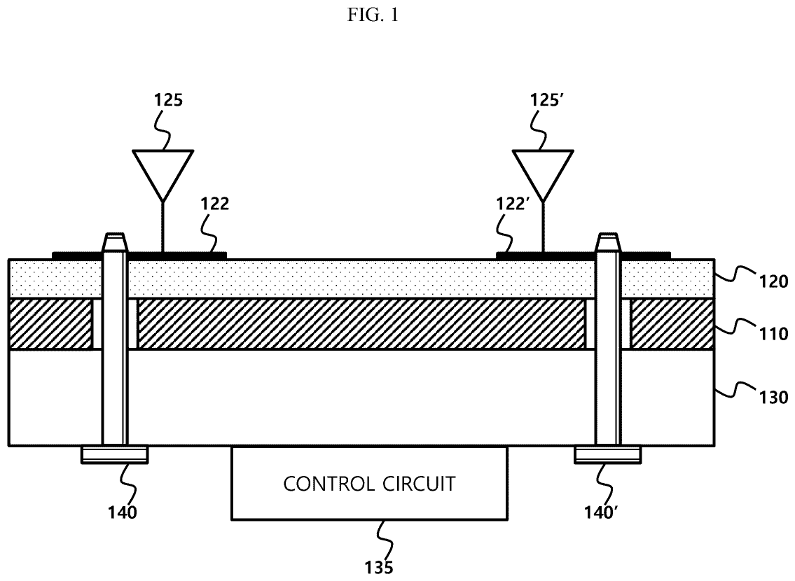

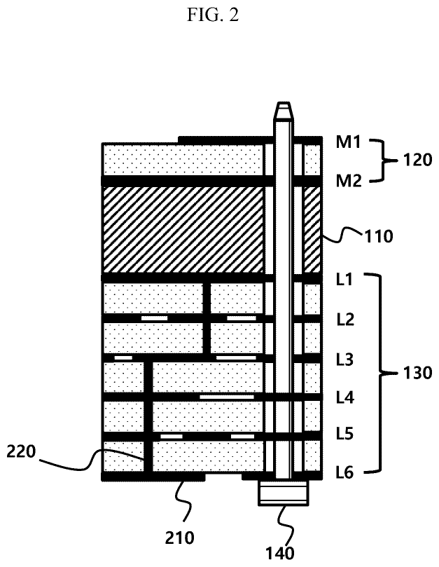

FIG. 1 is a sectional view illustrating an antenna element according to one embodiment of the present disclosure, and FIG. 2 is a view illustrating a stacked structure of the antenna element according to one embodiment of the present disclosure.

The antenna element according to one embodiment of the present disclosure includes two independent substrates to implement an antenna circuit and an RF control circuit with materials optimized therefor, respectively, and the substrates may be stacked via a metal plate.

As one embodiment, FIG. 1 illustrates the antenna element having a structure in which a first substrate 120 and a second substrate 130 are coupled to a metal plate 110 by two conductive pins 140 and 140′. However, the number of conductive pins and antennas included in the antenna element is not limited thereto. That is, the antenna element according to the present disclosure may include at least one antenna as necessary, and the plate 110, the first substrate 120, and the second substrate 130 may be coupled by conductive pin(s) in a number corresponding to or greater than the number of antennas included in the antenna element. Hereinafter, as one embodiment, a structure of a dual polarization antenna element including two antennas will be described.

Referring to FIG. 1, the metal plate 110 may be disposed between the first substrate 120 and the second substrate 130 to structurally support the antenna element and to shield electromagnetic interference between the first substrate 120 and the second substrate 130.

The first substrate 120 may include at least one antenna feeding port 122 or 122′ and may be joined to one side of the metal plate 110. An antenna 125 or 125′ may be provided at the antenna feeding port 122 or 122′. Here, the antenna 125 or 125′ may include a patch antenna, a dipole antenna, a monopole antenna, etc. That is, various types of antennas may be mounted on the first substrate 120.

The second substrate 130 may be joined to the other side of the metal plate 110, and may include a transmission path for an RF signal input and output through at least one antenna feeding port 122 or 122′. To this end, the second substrate 130 may include an RF input/output pad and may have a multilayer structure. Further, a control circuit 135 may be mounted on one side of the second substrate 130. The control circuit 135 may be referred to as an RFIC (Radio Frequency Integrated Circuit), and may be provided on a flip chip.

The first substrate 120 and the second substrate 130 may be coupled to the metal plate 110 by conductive pins 140 and 140′. To this end, the metal plate 110 may include at least one through-hole, and the conductive pins 140 and 140′ may be inserted into the respective through-holes. In this case, one end (or both ends) of each conductive pin 140 or 140′ may be soldered to the first substrate 120 and/or the second substrate 130, thereby forming stable contacts with the first substrate 120 and the second substrate 130.

The conductive pins 140 and 140′ may electrically connect a transmission path provided in the second substrate 130 with the antenna feeding ports 122 and 122′ provided in the first substrate 120. Thus, a signal generated by the control circuit 135 may be applied to the conductive pins 140 and 140′ through the transmission path provided in the second substrate 130, and then supplied to the antenna feeding ports 122 and 122′. Likewise, signals received through the antennas 125 and 125′ may be applied to the conductive pins 140 and 140′, and then transmitted to the control circuit 135 through the transmission path provided in the second substrate 130.

Meanwhile, the first substrate 120 may be made of a material that minimizes return loss (e.g. high-frequency loss), and the second substrate 130 may be made of a material having an optimal coefficient of thermal expansion. To this end, the first substrate 120 and the second substrate 130 may have different physical properties. As one example, the first substrate 120 and the second substrate 130 may have different dielectric permittivities and/or different thicknesses.

Non-limitingly but more specifically, the first substrate 120 may have a lower dielectric constant than the second substrate 130. Further, the first substrate 120 may have a thinner thickness than the second substrate 130, as illustrated in FIG. 2. Referring to FIG. 2, the first substrate 120 may include a first metal layer M1 in which the antenna feeding ports are formed, and a second metal layer M2 in which a ground plane is formed. A dielectric layer may be provided between the first metal layer M1 and the second metal layer M2.

The second substrate 130 may have a structure in which a plurality of dielectric layers and a plurality of metal layers L1 to L6 are alternately stacked. The metal layers L1 to L6 may be provided with transmission lines 210 formed to implement various polarizations, and the respective metal layers L1 to L6 may be connected by vias 220. Thus, the signal generated by the control circuit 135 may be transmitted to the conductive pin 140 through the transmission lines 210 and/or the vias 220 formed in the second substrate 130. The signal applied to the conductive pin 140 may be transmitted to the antenna feeding port formed in the first metal layer M1 through the metal plate 110, and then radiated through the antenna (or radiator) provided at the corresponding antenna feeding port. That is, RF input/output (or feeding connection) between the first substrate 120 and the second substrate 130 may be performed by the conductive pin 140.

As such, since the antenna element according to one embodiment of the present disclosure has a structure in which the first substrate 120 and the second substrate 130 are separated by the metal plate 110, fabrication may be simplified and production costs may be reduced. Further, since each substrate 120 or 130 may be made of an optimal material, antenna performance such as radiation efficiency may be maximized.

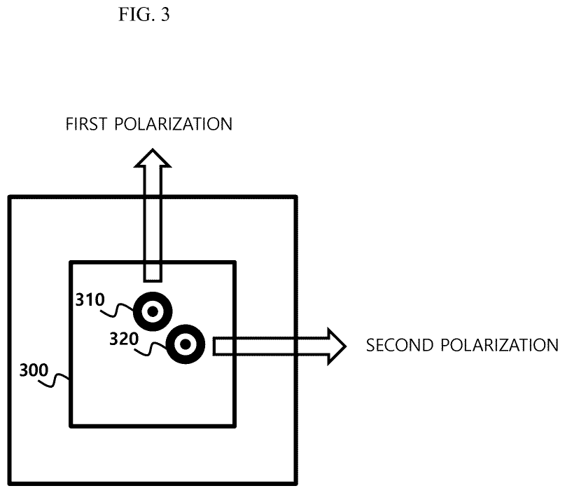

FIG. 3 is a plan view illustrating an antenna element according to one embodiment of the present disclosure.

Referring to FIG. 3, the antenna element 300 according to one embodiment of the present disclosure may include a first polarization port 310 and a second polarization port 320. Polarization generated by the first polarization port 310 and polarization generated by the second polarization port 320 may be orthogonal to each other. As one example, the antenna element may be implemented such that vertical polarization is generated at the first polarization port 310 and horizontal polarization is generated at the second polarization port 320. Signals output from a control circuit of the antenna element 300 may be transmitted to the respective polarization ports 310 and 320 through two or more conductive pins.

In one embodiment of the present disclosure, a signal applied to the first polarization port 310 through a first conductive pin may be controlled to have a preset phase difference with respect to a signal applied to the second polarization port 320 through a second conductive pin. The antenna element 300 may generate various polarizations depending on the phase difference between signals transmitted to the respective conductive pins. For example, when the phase of the signal applied to the first polarization port 310 is the same as the phase of the signal applied to the second polarization port 320, linear polarization may be generated in the antenna element 300. As another example, when a phase difference between the signal applied to the first polarization port 310 and the signal applied to the second polarization port 320 is 90 degrees, that is, when the two signals are combined with a 90-degree phase delay, circular polarization may be generated in the antenna element 300. Non-limitingly but more specifically, when horizontal polarization lags vertical polarization by 90 degrees, left-hand circular polarization (LHCP) may be generated in the antenna element 300, and when vertical polarization lags horizontal polarization by 90 degrees slower, right-hand circular polarization (RHCP) may be generated in the antenna element 300. As still another example, when a phase difference between the signal applied to the first polarization port 310 and the signal applied to the second polarization port 320 has any value other than 0 degrees and 90 degrees, elliptical polarization may be generated in the antenna element 300.

Thus, when the antenna element 300 is implemented to generate circular polarization or elliptical polarization, a first path connected to the first conductive pin and a second path connected to the second conductive pin in the second substrate may have different lengths. That is, a length of a transmission line connected to the first conductive pin and a length of a transmission line connected to the second conductive pin in the second substrate may be different from each other. To this end, as one example, a difference between the length of the first path and the length of the second path may be determined based on a wavelength of an RF signal.

The RF signal propagates on the substrate at c/\sqrt{68 _{eff}} speed lower than light speed c depending on a dielectric constant ϵᵣ. At an operating frequency f, a wavelength λ in vacuum is c/f, and an effective wavelength λ_{eff} on the substrate is calculated as λ/\sqrt{ϵ_{eff}}. Since a phase difference of 90 degrees corresponds to one quarter of the effective wavelength λ_{eff}, an electrical path length difference Δl required to implement a 90-degree phase difference between two signals on the substrate is calculated as λ_{eff}/4. Thus, as one example, in order to implement the 90-degree phase difference between two signals based on a difference in trace length within the substrate at 14 GHz, a length difference of approximately 2.68 mm is required. Therefore, when trace lengths within the substrate are adjusted such that a length difference between two paths through which signals are transmitted from the control circuit to antenna feeding portions becomes Δl, signals actually applied to the respective antenna ports may have the phase difference of 90 degrees. However, a signal propagation speed in the substrate may vary depending on a trace width within the substrate, a thickness of the substrate, material properties, and the like. Therefore, the antenna element 300 according to one embodiment of the present disclosure may be designed such that an actual electrical length, defined as a sum of a physical length and a material-dependent correction value, matches Δl while taking all of these factors into consideration. That is, a difference between a length of the first path and a length of the second path in the second substrate may be determined based on a thickness of the second substrate, a trace width within the second substrate, and physical properties of the second substrate.

Meanwhile, at least one of the second substrate and the control circuit of the antenna element 300 may include a time delay circuit configured to generate a time delay between a signal applied to the first conductive pin and a signal applied to the second conductive pin. The time delay circuit may, for example, be implemented based on a PLL (Phase Locked Loop), and may operate based on a frequency of an RF signal.

Since the period T of the RF signal is 1/f and the phase difference of 90 degrees corresponds to one quarter of the signal period, a time delay T_delay required to implement the circular polarization is determined as T/4, that is, ¼f. Therefore, as one example, in order to implement an exact 90-degree phase difference for a 14 GHz signal, a time delay of approximately 17.85 ps is required. Thus, the control circuit may control a phase difference between a signal applied to the first conductive pin and a signal applied to the second conductive pin using the time delay circuit, thereby enabling the antenna element 300 to radiate various polarizations, such as linear polarization, circular polarization, and elliptical polarization.

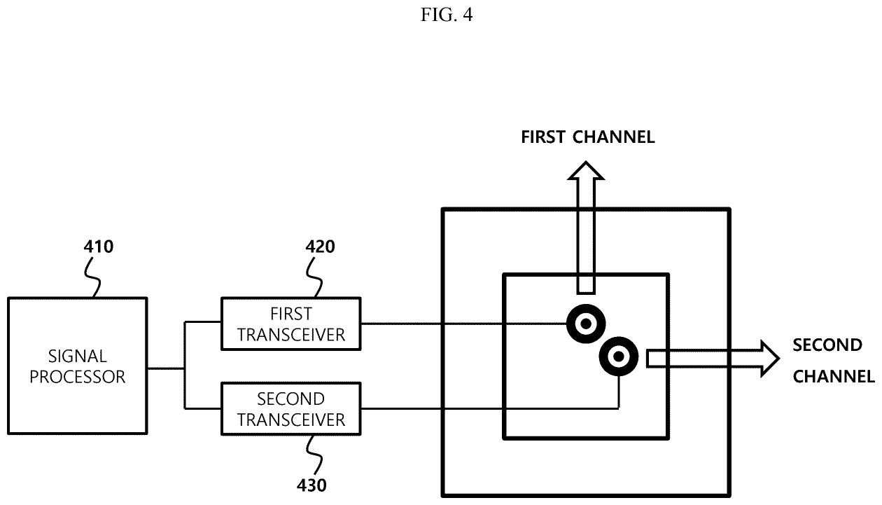

FIG. 4 is a view illustrating a case in which the antenna element according to one embodiment of the present disclosure operates in MIMO.

Referring to FIG. 4, the antenna element according to one embodiment of the present disclosure may be implemented such that different signals are applied to a first polarization port and a second polarization port, respectively, for use in a MIMO communication system. In this case, as illustrated in FIG. 4, a control circuit may include a signal processor 410, a first transceiver 420, and a second transceiver 430.

The signal processor 410 may independently control the signals transmitted to the respective polarization ports based on the first transceiver 420 and the second transceiver 430. A signal generated by the first transceiver 420 may be applied to the first conductive pin and transmitted to the first polarization port, and a signal generated by the second transceiver 430 may be applied to the second conductive pin and transmitted to the second polarization port. When each polarization port has an independent signal processing path as described above, the antenna element may simultaneously transmit or receive different data streams through a first channel and a second channel. In this case, channel capacity and/or communication reliability may be improved by spatial diversity. Further, inter-channel interference in the MIMO communication system may be minimized, and optimal multipath channel separation characteristics may be provided.

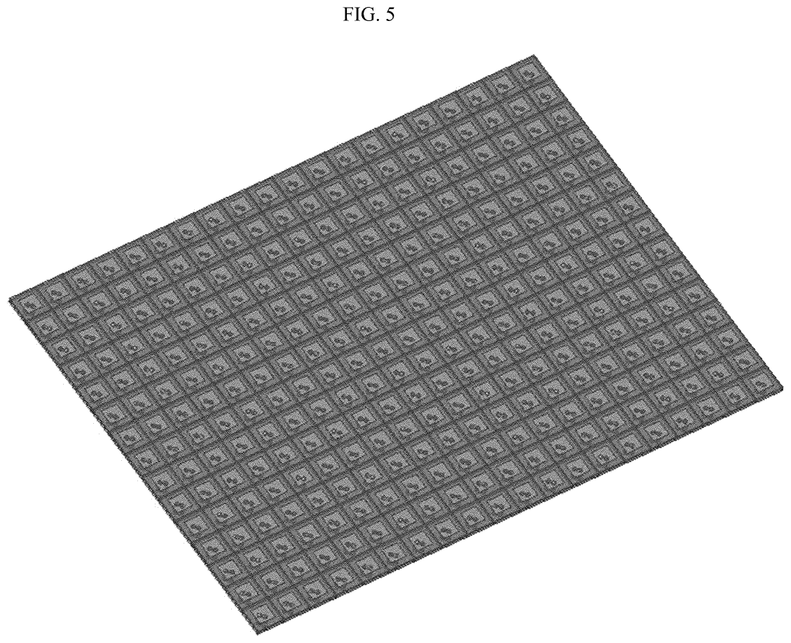

FIG. 5 is a plan view illustrating an antenna module included in a polarization reconfiguration antenna system according to one embodiment of the present disclosure.

The polarization reconfiguration antenna system according to one embodiment of the present disclosure may include an antenna module in which a plurality of antenna elements are arranged, and a control circuit configured to generate a signal applied to the antenna module.

The antenna module may have a structure in which the antenna elements are arranged in an M×N form as illustrated in FIG. 5, but is not limited thereto. That is, the polarization reconfiguration antenna system according to one embodiment of the present disclosure may also include the antenna module including the antenna elements arranged in a 1×N form, an M×1 form, or the like.

Further, the polarization reconfiguration antenna system according to one embodiment of the present disclosure may include a plurality of antenna modules as needed. For example, when the antenna module is configured in a form in which M antenna elements are arranged in a row, the polarization reconfiguration antenna system may include N antenna modules to form an M×N antenna array. As another example, when the antenna module is configured to include M×N antenna elements, the polarization reconfiguration antenna system may include K antenna modules to form an antenna array having a K(M×N) configuration.

Non-limitingly but more specifically, the antenna module may include a metal plate, a first substrate, and a second substrate. The first substrate may be provided on one side of the metal plate, and the second substrate may be provided on the other side of the metal plate. The metal plate, the first substrate, and the second substrate may be joined to each other by a plurality of conductive pins.

The first substrate may be provided with antenna feeding ports (or polarization ports), and various types of antennas may be provided at the respective antenna feeding ports. For example, antennas having the same configuration may be provided at the antenna feeding ports of the antenna module, or, as needed, antennas having different configurations may be provided at the respective antenna feeding ports.

The second substrate may be provided with transmission paths for transmitting RF signals to the respective antenna feeding ports. The transmission paths may include pads, traces, vias, and the like for RF input and output.

Each conductive pin may be inserted into the through-hole formed in the metal plate to physically connect the first substrate and the second substrate. Further, each conductive pin may electrically connect the antenna feeding port provided in the first substrate with the transmission path provided in the second substrate. Thus, signals generated by the control circuit may be applied to the respective conductive pins through the transmission paths provided in the second substrate, and then supplied to the corresponding antenna feeding ports.

The control circuit may reconfigure polarization generated by the antenna array by controlling a phase difference of signals transmitted to the respective antenna elements (or antennas) of the antenna module. To this end, as one example, the first path connected to the first conductive pin and the second path connected to the second conductive pin in the second substrate may have different lengths. Non-limitingly but more specifically, a difference between the length of the first path and the length of the second path may be determined by comprehensively considering the wavelength of the RF signal, the thickness of the second substrate, a trace width in the second substrate, and physical properties of the second substrate. Further, the control circuit and/or the second substrate may be provided with a time delay circuit configured to operate based on the frequency of the RF signal.

The control circuit may control speed at which RF signals are transmitted to the respective antenna feeding ports using the time delay circuit, thereby enabling various types of polarizations to be radiated from the antenna module, and may switch or reconfigure the polarization radiated from the antenna module in real time.

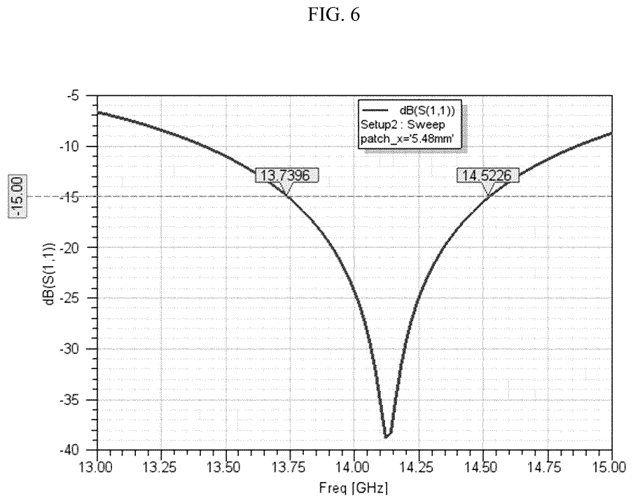

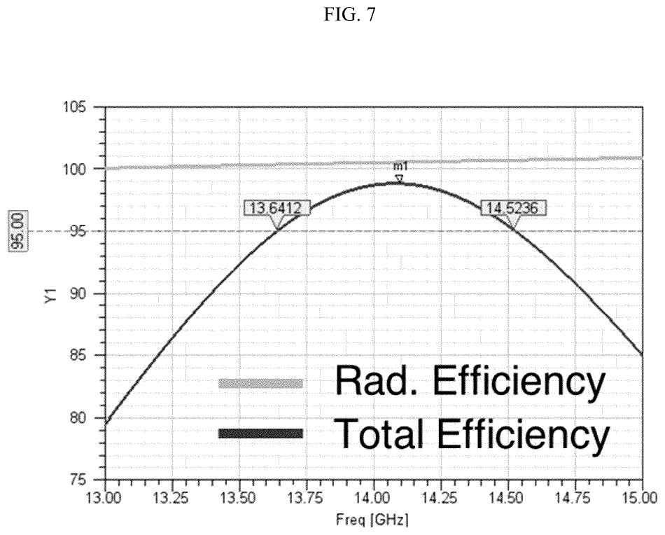

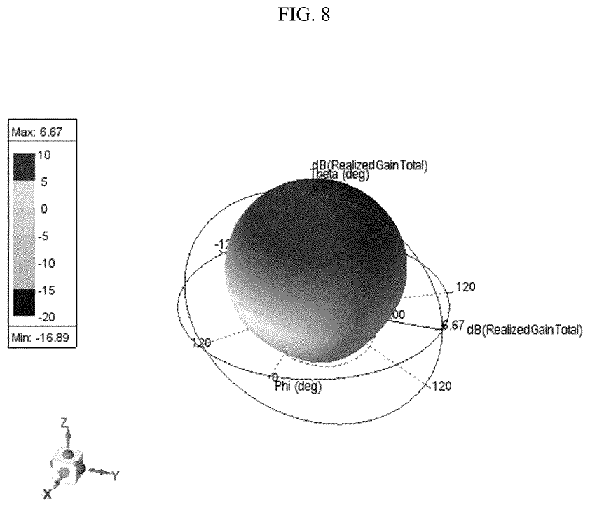

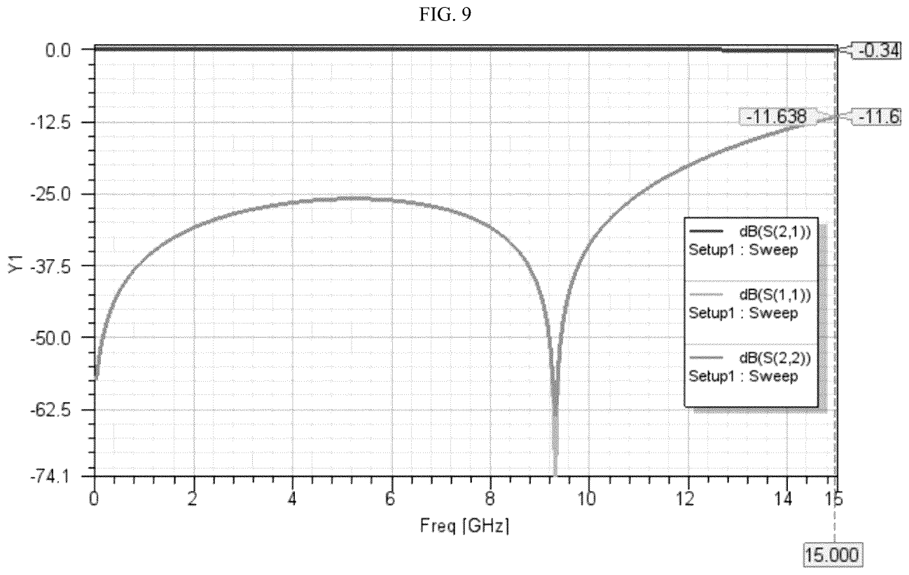

FIG. 6 is a view illustrating return loss of the antenna element according to one embodiment of the present disclosure, FIG. 7 is a view illustrating radiation efficiency of the antenna element according to one embodiment of the present disclosure, FIG. 8 is a view illustrating a radiation pattern of the antenna element according to one embodiment of the present disclosure, and FIG. 9 is a view illustrating connection loss between substrates of the antenna element according to one embodiment of the present disclosure.

Referring to FIGS. 6 and 7, the antenna element according to one embodiment of the present disclosure exhibits a return loss of −15 dB or less in a band from 13.75 GHz to 14.5 GHz, and a radiation efficiency of 95% or higher in a band from 13.65 GHz to 14.5 GHz. Further, referring to FIG. 8, it can be confirmed that the antenna element according to one embodiment of the present disclosure can obtain a high realized gain in all directions.

Meanwhile, referring to FIG. 9, it can be confirmed that the antenna element according to one embodiment of the present disclosure exhibits very low return and insertion losses between the antenna feeding port and the RF input/output pad, and also maintains an interconnection loss between the first substrate and the second substrate at a level of −3 dB. Therefore, according to one embodiment of the present disclosure, it can be confirmed that the antenna element exhibits optimized performance in the Ku band even though the antenna element has a structure in which heterogeneous substrates are joined to the metal plate.

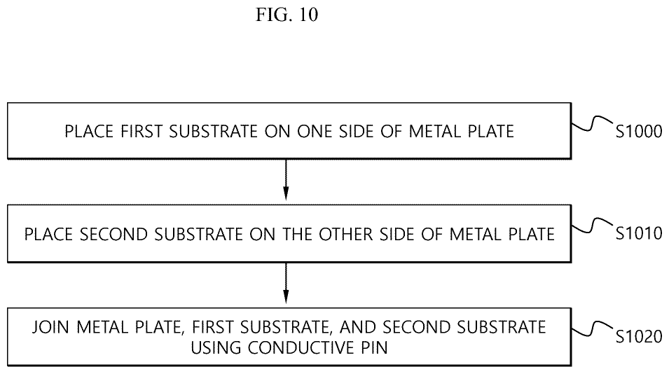

FIG. 10 is a view illustrating a method of manufacturing an antenna element according to one embodiment of the present disclosure.

Referring to FIG. 10, the antenna element according to one embodiment of the present disclosure may be manufactured through a process S1000 of placing a first substrate on one side of a metal plate, a process S1010 of placing a second substrate on the other side of the metal plate, and a process S1020 of joining the metal plate, the first substrate, and the second substrate using at least one conductive pin. Here, there is no limitation on a thickness, a type, or the like of the metal plate. For example, the metal plate may have a thickness that provides strength required by the system depending on the type of metal.

The first substrate and the second substrate may be made of materials having different physical properties. For example, the first substrate may be made of a material that minimizes the return loss of the antenna, and the second substrate may be made of a material having an optimized coefficient of thermal expansion. In this case, a dielectric permittivity of the first substrate may be lower than a dielectric permittivity of the second substrate, and a thickness of the first substrate may be thinner than a thickness of the second substrate.

Meanwhile, the at least one conductive pin may be fixed to the first substrate and the second substrate by a metal such as copper (Cu), tin (Sn), lead (Pb), or a mixture thereof. The first substrate may include at least one antenna feeding port, and the second substrate may include the transmission path for the RF signal. The control circuit of the antenna element may be provided on the second substrate. Thus, the RF signal generated by the control circuit may be applied to the conductive pin through the transmission path, and the signals applied to the conductive pin may be transmitted to the antenna feeding port.

Although the present disclosure has been described above with reference to the drawings and embodiments, it should be understood that the protection scope of the present disclosure is not limited by the drawings or the embodiments. Rather, those skilled in the art will appreciate that various modifications and changes may be made without departing from the spirit and scope of the present disclosure as set forth in the appended claims.

Although the present disclosure has been described based on a series of functional blocks, it is not limited to the above-described embodiments and the accompanying drawings, and it will be apparent to those skilled in the art that various substitutions, modifications, and alterations may be made without departing from the technical spirit of the present disclosure.

Combinations of the foregoing embodiments are not limited to the specific embodiments described above, and various combinations may be provided depending on implementation and/or requirements, in addition to the foregoing embodiments.

In the foregoing embodiments, the methods have been described based on flowcharts as a series of steps or blocks. However, the present disclosure is not limited to the order of the steps, and some steps may occur in a different order from that described above or may occur simultaneously. In addition, those skilled in the art will understand that the steps shown in the flowcharts are not exclusive, that other steps may be included, and that one or more of the steps shown in the flowchart may be omitted without affecting the scope of the present disclosure.

The foregoing embodiments include examples of various aspects. Although it is not possible to describe all possible combinations for illustrating the various aspects, those skilled in the art will recognize that other combinations are possible. Thus, the present disclosure is intended to embrace all such alterations, modifications, and variations that fall within the following claims.

What is claimed is:

1. An antenna element comprising:
a metal plate;
a first substrate joined to one side of the metal plate and including at least one antenna feeding port; and
a second substrate joined to the other side of the metal plate and including a transmission path for an RF (Radio Frequency) signal input and output through the at least one antenna feeding port,
wherein the first substrate and the second substrate are coupled to the metal plate by at least one conductive pin.

2. The antenna element of claim 1, wherein the first substrate and the second substrate have different physical properties.

3. The antenna element of claim 1, wherein the first substrate and the second substrate have different dielectric permittivities.

4. The antenna element of claim 1, wherein the first substrate and the second substrate have different thicknesses.

5. The antenna element of claim 1, wherein the first substrate has a thinner thickness than the second substrate.

6. The antenna element of claim 1, wherein the metal plate comprises at least one through-hole into which the at least one conductive pin is inserted.

7. The antenna element of claim 1, wherein the transmission path and the at least one antenna feeding port are electrically connected by the at least one conductive pin.

8. The antenna element of claim 1, wherein the at least one conductive pin is soldered to at least one of the first substrate and the second substrate.

9. The antenna element of claim 1, wherein:
the at least one conductive pin comprises:
a first conductive pin contacting a first antenna feeding port among the at least one antenna feeding port; and
a second conductive pin contacting a second antenna feeding port among the at least one antenna feeding port, and
a signal applied to the first conductive pin is controlled to have a preset phase difference with respect to a signal applied to the second conductive pin.

10. The antenna element of claim 9, wherein:
the transmission path comprises:
a first path connected to the first conductive pin; and
a second path connected to the second conductive pin, and the first path and the second path have different lengths.

11. The antenna element of claim 10, wherein a difference between the length of the first path and the length of the second path is determined based on a wavelength of the RF signal.

12. The antenna element of claim 10, wherein a difference between the length of the first path and the length of the second path is determined based on at least one of a thickness of the second substrate, a width of a trace formed in the second substrate, and physical properties of the second substrate.

13. The antenna element of claim 9, wherein the antenna element comprises a time delay circuit configured to generate a time delay between the signal applied to the first conductive pin and the signal applied to the second conductive pin.

14. The antenna element of claim 13, wherein the time delay circuit operates based on a frequency of the RF signal.

15. The antenna element of claim 9, wherein the antenna element radiates at least one of linear polarization and circular polarization according to the phase difference between the signal applied to the first conductive pin and the signal applied to the second conductive pin.

16. The antenna element of claim 1, wherein:
the at least one conductive pin comprises:
a first conductive pin contacting a first antenna feeding port among the at least one antenna feeding port; and
a second conductive pin contacting a second antenna feeding port among the at least one antenna feeding port, and
signals generated by different transceivers are applied to the first conductive pin and the second conductive pin, respectively.

17. A polarization reconfiguration antenna system comprising:
an antenna module in which a plurality of antenna elements are arranged; and
a control circuit configured to generate a signal applied to the antenna module,
wherein the antenna module comprises:
a metal plate;
a first substrate provided on one side of the metal plate and including a plurality of antenna feeding ports;
a second substrate provided on the other side of the metal plate and including transmission paths for RF signals input and output through the plurality of antenna feeding ports; and
a plurality of conductive pins configured to join the metal plate, the first substrate, and the second substrate.

18. A method of manufacturing an antenna element, the method comprising:
placing a first substrate including at least one antenna feeding port on one side of a metal plate;
placing a second substrate including a transmission path for an RF signal input and output through the at least one antenna feeding port on the other side of the metal plate; and
joining the metal plate, the first substrate, and the second substrate using at least one conductive pin.
